(19) United States
(12) Patent Application Publication
(10) Pub. No.: US 2024/0419996 A1
(43) Pub. Date: Dec. 19, 2024

(54) SYSTEM AND METHOD FOR ANALYZING THE STRUCTURE OF A PROBABILITY TREE

(71) Applicant: GM GLOBAL TECHNOLOGY OPERATIONS LLC, Detroit, MI (US)

(72) Inventors: Ronit Bustin, Kfar Saba (IL); Claudia V. Goldman-Shenhar, Mevasseret Zion (IL)

(73) Assignee: GM GLOBAL TECHNOLOGY OPERATIONS LLC, Detroit, MI (US)

(21) Appl. No.: 18/336,115

(22) Filed: Jun. 16, 2023

(51) Int. Cl. G06N 7/01

(52) U.S. Cl. CPC G06N 7/01

(57) ABSTRACT

A method of performing a probability tree analysis. The method includes identifying a plurality of nodes in a probability tree with each of the plurality of nodes having a probability vector. At least one node structural value is calculated for each of the plurality of nodes. The at least one node structural value quantifies an entropy of a subtree extending from a corresponding one of the plurality of nodes. The at least one node structural value is assigned to a corresponding one of the plurality of nodes. An analyzed probability tree is output including the at least one node structural value assigned to the corresponding one of the plurality of nodes.

### INTRODUCTION

The subject disclosure relates to automated decision making and, in particular, to a system and method for analyzing the structure of a probability tree.

Artificial Intelligence (AI) can be used in an autonomous or semi-autonomous vehicle to determine an action for the vehicle to take. AI algorithms are applied to compute and determine driving behaviors for semi-autonomous and fully autonomous vehicles through generating probability trees. Probability trees (rooted graphs with probabilities on each vertex) are common data structures used in many automated systems (e.g., systems or machines making automated decisions such as automated vehicles). An example of such a tree is a Monte Carlo Tree Search (MCTS) that generates a probability tree structure as the output for sequential decision making. To reach a decision, the algorithm builds the probability tree data structure with the root node being the current state and each vertex being a different action that can be taken from the root node.

### SUMMARY

Disclosed here is a method of performing probability tree analysis. The method includes identifying a plurality of nodes in a probability tree with each of the plurality of nodes having a probability vector. At least one node structural value is calculated for each of the plurality of nodes. The at least one node structural value quantifies an entropy of a subtree extending from a corresponding one of the plurality of nodes. The at least one node structural value is assigned to a corresponding one of the plurality of nodes. An analyzed probability tree is output including the at least one node structural value assigned to the corresponding one of the plurality of nodes.

Another aspect of the disclosure may be where the entropy defines a span of the subtree extending from a corresponding one of the plurality of nodes.

Another aspect of the disclosure may be where the subtree includes at least one branch extending therefrom and the probability vector includes a number of values that matches a number of branches in the at least one branch extending with values in the probability vector corresponding to a size of the subtree extending therefrom.

Another aspect of the disclosure may be where the at least one node structural value includes a normalized node structural value and a non-normalized node structural value.

Another aspect of the disclosure may be where the normalized node structural value provides a value for comparison between different layers of the probability tree.

Another aspect of the disclosure may be where the probability tree is generated from a Monte Carlo Tree Search.

Another aspect of the disclosure may include generating an updated probability tree based on the at least one node structural value in the analyzed probability tree.

Another aspect of the disclosure may include generating an updated probability tree based on the analyzed probability tree. A plurality of nodes is identified in the updated probability tree. At least one node structural value is calculated for each of the plurality of nodes in the updated probability tree. The at least one node structural value is assigned to a corresponding one of the plurality of nodes in the updated probability tree. The updated probability tree is output including the at least one node structural value assigned to the corresponding one of the plurality of nodes.

Another aspect of the disclosure may be where the analyzed probability tree proceeds the updated probability tree by at least one time step.

Another aspect of the disclosure may be where the probability tree was generated prior to identifying the plurality of nodes in the probability tree.

Another aspect of the disclosure may be where identifying the plurality of nodes and calculating at least one node structural value for each of the plurality of nodes occurs during generation of the probability tree with a construction algorithm.

Another aspect of the disclosure may be where the updated probability tree includes at least one node corresponding to a node in the probability tree with a reduced span extending therefrom.

Another aspect of the disclosure may include determining a degree of similarity between the probability tree and the updated probability tree by comparing the at least one node structural value for at least one corresponding node between the probability tree and the updated probability tree.

Another aspect of the disclosure may include increasing a quantity of branches spanning from at least one node of the plurality of nodes in the updated probability tree if the at least one node structural value for the analyzed probability tree is below a predetermined value.

Another aspect of the disclosure may include limiting a quantity of branches spanning from at least one node of the plurality of nodes in the updated probability tree if the at least one node structural value for the analyzed probability tree is greater than a predetermined structural value.

Another aspect of the disclosure may include providing an explanation regarding possible decisions considered from the probability tree based on the at least one node structural value.

Disclosed herein is a non-transitory computer-readable medium embodying programmed instructions which, when executed by a processor, are operable for performing a method. The method includes identifying a plurality of nodes in a probability tree with each of the plurality of nodes including a probability vector. At least one node structural value is calculated for each of the plurality of nodes, wherein the at least one node structural value quantifies an entropy of a subtree extending from a corresponding one of the plurality of nodes. The at least one node structural value is assigned to a corresponding one of the plurality of nodes. An analyzed probability tree is output including the at least one node structural value assigned to the corresponding one of the plurality of nodes.

Disclosed herein is an automated system. The automated system includes a plurality of sensors and a controller in communication with the plurality of sensors. The controller is configured to identify a plurality of nodes in a probability tree where each of the plurality of nodes includes a probability vector. The controller is also configured to calculate at least one node structural value for each of the plurality of nodes where the at least one node structural value quantifies an entropy of a subtree extending from a corresponding one of the plurality of nodes. The controller is further configured to assign the at least one node structural value to a corresponding one of the plurality of nodes and output an analyzed probability tree including the at least one node structural value assigned to the corresponding one of the plurality of nodes.

### DESCRIPTION OF THE DRAWINGS

FIG. 1 shows a vehicle that can be operated in an autonomous mode or automated mode, in accordance with an exemplary embodiment.

FIG. 2 shows a behavior model that can be used by the controller to select an action to be performed by the vehicle, in an illustrative embodiment.

FIG. 3 shows a flowchart of a method for performing probability tree analysis, in an illustrative embodiment.

Some embodiments of the present disclosure are now described, by way of example only, and with reference to the accompanying drawings. The same reference number represents the same element or the same type of element on all drawings.

### DETAILED DESCRIPTION

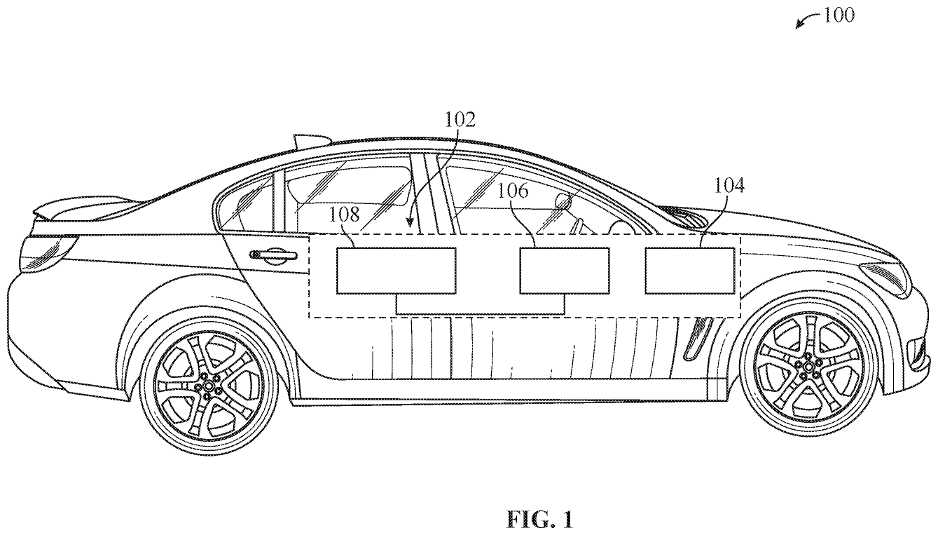

In accordance with an exemplary embodiment, FIG. 1 shows a vehicle 100 that can be operated in an autonomous mode or automated mode. The vehicle 100 can be a fully autonomous vehicle or a semi-autonomous vehicle. The vehicle 100 includes a driving system 102 that controls autonomous operation of the vehicle. The driving system 102 includes a sensor system 104 for obtaining information about the surroundings or environment of the vehicle 100, a controller 106 for computing possible actions for the autonomous vehicle based on the obtained information and for implementing one or more of the possible actions, and a human machine interface 108 for communicating with an occupant of the vehicle, such as a driver or passenger. The sensor system 104 can include devices such as cameras, Lidar, radar, GPS, etc.

The controller 106 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 106 may include a non-transitory computer-readable medium that stores instructions which, when processed by one or more processors of the controller 106, implement a method of analyzing the structure of at least one probability tree and providing a node structural value for at least one node in the probability tree, according to one or more embodiments detailed herein. The controller 106 can operate programs that perform artificial intelligence.

The human machine interface 108 can include one or more interfaces, such as a speaker, a display, a haptic device, etc. Each interface is suitable for a given modality of a message. For example, the speaker can be employed to present an aural message. The display can be employed to present a written message, graph, or animation. The haptic device can be employed to present tactile message, such as a vibration, that is felt by the occupant. In another embodiment, the human machine interface 108 can be a mobile device that can be used by the occupant either while inside the vehicle or outside the vehicle.

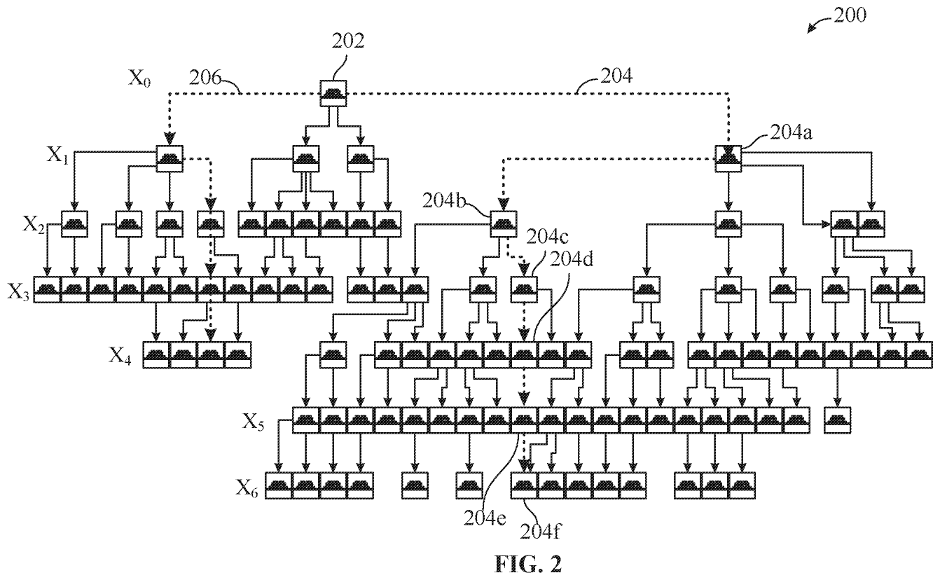

FIG. 2 shows a behavior model 200 that can be used by the controller 106 to select an action to be performed at the vehicle 100, in an illustrative embodiment. In the illustrated example, the behavior model 200 includes a probability tree having a plurality of nodes. An edge connects any two nodes of the probability tree. Each node represents a state of the vehicle 100, and each edge represents an action that takes the vehicle from one state to another state (a subsequent state or future state). The top node (or root node) of the probability tree represents a current state of the vehicle 100. Subsequent possible states are shown below the top node. Each action or edge has an associated probability. The state Xᵢ in the probability tree represents random variables receiving values from the possible actions (e.g., [RIGHT, LEFT, ACCELERATE, DECELERATE, NONE]). This defines a discrete time random process X₀, X₁, X₂, X₃, X₄, X₅, X₆ . . . , Xₙ where n is the depth of the tree.

A sequence of actions through the behavior model 200 is referred to as a trajectory. In using the behavior model 200, the controller 106 starts at the root node (i.e., the current state of the vehicle 100). The controller 106 selects an action to take by performing an optimization algorithm that considers all possible futures in the probability tree as evaluated from the root node. Once the action is executed, the vehicle now moves to a resulting state. The controller 106 identifies the resulting state as a new root node and a new tree is expanded so that the optimization algorithm can be performed from the new root node. The controller 106 can operate an artificial intelligence planning system to optimize a sequential decision-making process to arrive at an automated behavior. In one embodiment, the sequential decision-making process can be implemented as in the Monte Carlo Tree Search (MCTS) algorithm.

From the current state X₀ (first state 202) the controller 106 can calculate a plurality of trajectories through the probability tree to reach a desired end state or subsequent state and can calculate probabilities for each of the trajectories. A first expected trajectory 204 and a second expected trajectory 206 are shown for illustrative purposes. The first expected trajectory passes sequentially through states 204a, 204b, 204c, 204d, 204e, and 204f. For illustrative purposes, the first expected trajectory 204 can be a trajectory that has a highest expected value based on the decision process.

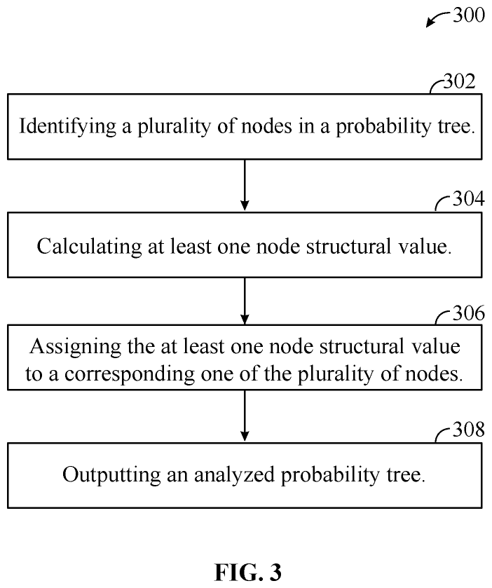

FIG. 3 shows a flowchart of a method 300 of analyzing at least one probability tree, such as on the behavior model 200 shown in FIG. 2. The method 300 can be applied either post-hoc on an existing probability tree or on an iterative basis during construction of a probability tree. The analysis of the probability tree provides a node structural value that describes a structure of branches, or a subtree, spanning from a given node in the probability tree. The subtree includes at least one branch extending therefrom and the probability vector includes a number of values that matches a number of branches in the at least one branch extending therefrom. Furthermore, the values in the probability vector correspond to the size of the subtrees of the children's nodes. This allows the analysis performed by the method 300 to relate to the structure of the probability tree. Thus, instead of going down the probability tree and depicting its structure, the node structural value indicates the structure of the probability tree spanning from each of the nodes. Larger node structural values reflect more uncertainty in the probability tree. This corresponds to wider trees (e.g., more branches in the different layers of the subtree). The node structural values can be normalized to reflect the uncertainty per-node, so that a smaller subtree can be compared with a larger subtree.

The method 300 includes identifying a plurality of nodes in a probability tree (Block 302). While this disclosure describes the method 300 being used in connection with the driving system 102, the method 300 can be used with any automated system that generates or outputs a probability tree. The nodes can be from a probability tree that was previously constructed, or the nodes can be from a probability tree that is being constructed by a construction algorithm. The method 300 then calculates at least one node structural value for each of the nodes (Block 304). The node structural values provide an entropy value for a given node to describe a structure of the probability tree spanning from that node. For nodes that do not include branches or a subtree, the node structural value is zero. However, this disclosure is not limited to behavior models that are analyzed in real time, offline, or consider the time when the entropy measures are computed.

EQS. 1-5 below illustrate an example approach for calculating the node structural value or entropy of a given node. EQ. 1 below provides a naming format to measure the entropy, Tᵢ denoted by a possible backwards path to a node at depth i with T₀ being empty. EQ. 2 provides a naming format to measure the entropy, Tⁱ denoted by a possible forwards path to a node at depth i.

$${T}_{i} = {X}_{0} , {X}_{1} , … , {X}_{i - 1} \qquad EQ . 1$$

$${T}^{i} = {X}_{i} , {X}_{i + 1} , … {X}_{n} \qquad EQ . 2$$

EQ. 3 illustrates an equation that can be implemented recursively on a probability tree to determine the entropy and assign at least one node structural value to a corresponding one of the plurality of nodes in the probability tree, such as an existing probability tree. The function H( ) from EQ. 3 refers to the entropy function, Pr(Xᵢ=xⱼ|Tᵢ=t) is the conditional probability of Xᵢ getting value xⱼ when Tᵢ has value t (that is a specific trajectory). In EQ. 3 below, the variable [symbol] represents an action space of the probability tree. The action space represents various possible actions that are contemplated and from among which a desired outcome can be selected.

$$H ( {T}^{i} \vert {T}_{i} = t ) = H ( {X}_{i} \vert {T}_{i} = t ) + {\sum }_{j ∈ [ \vert 𝒜 \vert ]} P r ( {X}_{i} = {x}_{j} \vert {T}_{i} = t ) H ( {T}^{i + 1} \vert {T}_{i} = t , {X}_{i} = {x}_{j} ) \qquad EQ . 3$$

$$H ( {T}^{i} \vert {T}_{i} = t ) = H ( {X}_{i} \vert {T}_{i} = t ) + {\sum }_{j ∈ [ \vert 𝒜 \vert ]} P r ( {X}_{i} = {x}_{j} \vert {T}_{i} = t ) H ( {T}^{i + 1} \vert {T}_{i} = t , {X}_{i} = {x}_{j} )$$

While an output value based on the calculation from EQ. 3 above provides the node structural value of a given node in the probability tree, to compare the values between trees in different layers, the values are normalized as shown in EQ. 4 below. Therefore, EQ. 3 will provide a non-normalized node structural value and EQ. 4 will provide a normalized value for a given node in the probability tree. EQ. 4 denotes the average, per time-step, entropy as H(X̅).

$$\frac{H ( {X}_{0} , {X}_{1} , … , {X}_{n} )}{ℓ} \leq H ( \overline{X} ) \leq \frac{H ( {X}_{0} , {X}_{1} , … , {X}_{n} )}{{ℓ}_{L B}} \qquad EQ . 4$$

The variable [symbol] in EQ. 4 above is the depth of the subtree which is extracted from the probability tree. If leaves or ends of the branches are assumed to have zero entropy, then the lower bound is exact. If the process continues and truncates the leaves, then this creates an upper bound on H (\bar {X}) using [symbol] . The lower bound [symbol] is described in EQ. 5 below.

$$ℓ \geq {log}_{\vert 𝒜 \vert} ( N ( \vert 𝒜 \vert - 1 ) + 1 ) = {ℓ}_{L B} \qquad EQ . 5$$

The variable [symbol] can be replaced (and make the upper bound sharper) by the actual number of branches that have been expanded in the probability tree. The actual number of branches can be considerable when there is a very large action space, where most actions may not be valid or explored further.

Alternatively, the method 300 can be incorporated or piggyback onto a standard construction algorithm for a probability tree, such as the MCTS algorithm, to determine the entropy of a node. When the method 300 is incorporated into the standard construction algorithm, the root node is initially identified and corresponds to the layer X₀ shown in FIG. 2. As the probability tree is being formed with the addition of new nodes spanning from the root node, at least one node structural value is calculated for each of the nodes in the probability tree. The at least one node structural value can include both a normalized value and a non-normalized value depending on a desired use of the node structural values. This allows for at any point during the construction of the probability tree to have intermediate node structural values (normalized and non-normalized) available that are iteratively updated as the probability tree grows. Nodes identified during the construction process that do not include branches or a subtree will also have a single node structural value of zero.

In one example, the node structural values for two identical probability trees will be unchanged whether the analysis is performed on an existing tree or performed during construction of the probability tree. However, as will be discussed in greater detail below, the node structural values can be used to guide the construction of the probability tree such that the analysis incorporated into the construction of a probability tree may result in growth or reduction of the probability tree in certain areas depending on the node structural values.

In one example embodiment, the incorporation of the method 300 into the standard construction algorithm occurs in a back-propagation step. In the standard construction algorithm, the back propagation updates the value and number of visits from the leaf, or distal end of the branch, up the probability tree to the root node. With the method 300, the node structural value or entropy of the tree is updated with an encapsulated approach and a calculation of the depth of each node to facilitate the normalization of the entropy (lower bound) (See Block 304).

With the node structural values calculated using either the approach for an existing probability tree or a probability tree during construction as outlined above, the method 300 assigns the at least one normalized or non-normalized node structural value to a corresponding one of the plurality of nodes at Block 306. The method 300 can then output an analyzed probability tree that includes the at least one node's structural value assigned to the corresponding one of the plurality of nodes at Block 308.

The analyzed probability tree from Block 308 can then be provided back to the driving system 102 or automated system for further analysis or development of an updated probability tree based on the analyzed probability tree as will be discussed in greater detail below.

One feature of determining node structural values or entropy of the probability tree is generating an enhanced probability tree construction algorithm and directing a search by the driving system 102. The node structural values can also serve as a measure of determining whether the resulting search by the system 102 explored sufficiently the action space. This measure can also be used for a meaningful reduction of the probability tree for purposes of storage or simplification. Furthermore, the node structural values can be used for expandability for both developers and drivers/passengers, either with respect to a given probability tree or as a measure used for comparison between consecutive probability trees based on time to assess the occurrence of meaningful changes.

Probability trees are created at every time step of the planning system and can include creating several probability trees every second. Storing the probability trees for backup or post-hoc validation is limited by an amount of storage available. A quantity of nodes in the probability tree also limits the analysis that can be performed on the probability tree and communicating probability trees to a back office is also costly. Therefore, using the node structural value to limit or reduce the number of nodes in the probability tree can improve the amount of analysis being performed, such as by allowing the probability tree to be communicated to a back office, such as a remote computing location, for analysis.

Probability trees are created at every time step of the planning system. A standard approach in decision making based on probability trees is to consider not the last probability tree but also previous probability trees, to examine whether the decisions are consistent. This is done by comparing the probability trees from a sequence of time steps. However, the probability trees are not identical because their construction is probabilistic but assessing a level of similarity between the probability trees is still informative in the decision-making process for the system 102. The node structural values can also provide a way to make a comparison by comparing node structural values between corresponding nodes in different probability trees. If the node structural values are within a predetermined range, then the probability trees are considered to be similar. If the node structural values are not within a predetermined range, then the probability trees are not considered to be similar.

The driving system 102 generates probability trees to determine the actions the vehicle 100 is about to perform. Explaining these decisions to the driver/passengers is done in order to increase trust in the decisions made by the system 102. Engineers developing these systems can also benefit from explanations that describe the reasoning process of the original system. An algorithm for providing an explanation of actions can benefit from having a structural measurement, such as the node structural value, which indicates what options were considered by the planning algorithm, and to what extent (the reasoning process of the planning algorithm) the options were considered. The explanation of the decision by the automated system can be provided through the interface 108 to the user of the vehicle 100.

While probability trees are constructed based on an algorithm that expands the trees from the current state, the construction of probability trees is limited by computation power and time. The node structural values can be used to examine the construction process at intermediate points to evaluate whether the algorithm has explored sufficiently in a specific direction and perhaps indicate that the process can be stopped, saving computations. With this example application of the node structural values, the analyzed probability tree with the node structural values is provided as feedback to the automated system, such as the driving system 102, for constructing a next time iteration of the probability tree or updated probability tree. The feedback gained from reviewing the analyzed probability tree with node structural values can instruct the automated system where expansion of the probability tree may be helpful and where expansion may not be required.

Some automated systems consider the value of the actions taken and prefer to reconsider actions multiple times that had stronger priors or have shown to be promising. The node structural values can be considered as an additional independent parameter in balancing the search in directions that have not been considered enough. One feature of incorporating node structural values into probability trees and specifically the implementation occurring during construction of the probability tree, is that node structural values are incorporated into every intermediate tree, thus these values are available throughout the tree construction process to guide construction of the tree.

While various embodiments have been described, the description is intended to be exemplary rather than limiting. It will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

What is claimed is:

1. A method of performing probability tree analysis, the method comprising:
identifying a plurality of nodes in a probability tree, wherein each of the plurality of nodes includes a probability vector;
calculating at least one node structural value for each of the plurality of nodes, wherein the at least one node structural value quantifies an entropy of a subtree extending from a corresponding one of the plurality of nodes;
assigning the at least one node structural value to a corresponding one of the plurality of nodes; and
outputting an analyzed probability tree including the at least one node structural value assigned to the corresponding one of the plurality of nodes.

2. The method of claim 1, wherein the entropy defines a span of the subtree extending from a corresponding one of the plurality of nodes.

3. The method of claim 1, wherein the subtree includes at least one branch extending therefrom and the probability vector includes a number of values that matches a number of branches in the at least one branch extending therefrom with the values in the probability vector corresponding to a size of the subtree extending therefrom.

4. The method of claim 1, wherein the at least one node structural value includes a normalized node structural value and a non-normalized node structural value.

5. The method of claim 4, wherein the normalized node structural value provides a value for comparison between different layers of the probability tree.

6. The method of claim 1, wherein the probability tree is generated from a Monte Carlo Tree Search.

7. The method of claim 1, including generating an updated probability tree based on the at least one node structural value in the analyzed probability tree.

8. The method of claim 7, including:
generating an updated probability tree based on the analyzed probability tree;
identifying a plurality of nodes in the updated probability tree;
calculating at least one node structural value for each of the plurality of nodes in the updated probability tree;
assigning the at least one node structural value to a corresponding one of the plurality of nodes in the updated probability tree; and
outputting the updated probability tree including the at least one node structural value assigned to the corresponding one of the plurality of nodes.

9. The method of claim 8, wherein the analyzed probability tree proceeds the updated probability tree by at least one time step.

10. The method of claim 1, wherein the probability tree was generated prior to identifying the plurality of nodes in the probability tree.

11. The method of claim 1, wherein identifying the plurality of nodes and calculating at least one node structural value for each of the plurality of nodes occurs during generation of the probability tree with a construction algorithm.

12. The method of claim 8, wherein the updated probability tree includes at least one node corresponding to a node in the probability tree with a reduced span extending therefrom.

13. The method of claim 8, including determining a degree of similarity between the probability tree and the updated probability tree by comparing the at least one node structural value for at least one corresponding node between the probability tree and the updated probability tree.

14. The method of claim 8, including increasing a quantity of branches spanning from at least one node of the plurality of nodes in the updated probability tree if the at least one node structural value for the analyzed probability tree is below a predetermined value.

15. The method of claim 8, including limiting a quantity of branches spanning from at least one node of the plurality of nodes in the updated probability tree if the at least one node structural value for the analyzed probability tree is greater than a predetermined structural value.

16. The method of claim 1, including providing an explanation regarding possible decisions considered from the probability tree based on the at least one node structural value.

17. A non-transitory computer-readable medium embodying programmed instructions which, when executed by a processor, are operable for performing a method comprising:
identifying a plurality of nodes in a probability tree, wherein each of the plurality of nodes includes a probability vector;
calculating at least one node structural value for each of the plurality of nodes, wherein the at least one node structural value quantifies an entropy of a subtree extending from a corresponding one of the plurality of nodes;
assigning the at least one node structural value to a corresponding one of the plurality of nodes; and
outputting an analyzed probability tree including the at least one node structural value assigned to the corresponding one of the plurality of nodes.

18. The computer-readable medium of claim 17, wherein the entropy defines a span of the subtree extending from a corresponding one of the plurality of nodes.

19. The computer-readable medium of claim 17, wherein the method includes:
generating an updated probability tree based on the analyzed probability tree;
identifying a plurality of nodes in the updated probability tree;
calculating at least one node structural value for each of the plurality of nodes in the updated probability tree;
assigning the at least one node structural value to a corresponding one of the plurality of nodes in the updated probability tree; and
outputting the updated probability tree including the at least one node structural value assigned to the corresponding one of the plurality of nodes.

20. An automated system comprising:
a plurality of sensors;
a controller in communication with the plurality of sensors and configured to:
identify a plurality of nodes in a probability tree, wherein each of the plurality of nodes includes a probability vector;
calculate at least one node structural value for each of the plurality of nodes, wherein the at least one node structural value quantifies an entropy of a subtree extending from a corresponding one of the plurality of nodes;
assign the at least one node structural value to a corresponding one of the plurality of nodes; and
output an analyzed probability tree including the at least one node structural value assigned to the corresponding one of the plurality of nodes.
